(19) United States
(12) Patent Application Publication
(10) Pub. No.: US 2002/0135850 A1
(43) Pub. Date: Sep. 26, 2002

(54) Multistage rotatable actuator

(76) Inventors: Paul M. Hagelin, Saratoga, CA (US); David R. Pedersen, Sunnyvale, CA (US); Troy J. Edwards, Alameda, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/099,120

(22) Filed: Mar. 15, 2002

Related U.S. Application Data
(60) Provisional application No. 60/276,705, filed on Mar. 15, 2001.

(51) Int. Cl. G02B 26/08

(52) U.S. Cl. 359/224; 359/298

(57) ABSTRACT

A multistage actuator for steering a beam of light is disclosed. The multistage actuator includes a movable portion of an actuator drive mechanism, a first rotatable actuator drive mechanism coupled to the movable portion of the actuator drive mechanism, and a second rotatable actuator member coupled to the first rotatable actuator member. The first rotatable actuator member traverses a first angle and the second rotatable actuator member traverses a second angle when the movable portion of the actuator drive mechanism is displaced. An optical element such as a micromirror may be coupled to the second rotatable actuator member or additional actuator stages. An optical subassembly containing a plurality of optical mirrors and multistage rotatable actuators on a substrate is disclosed. Also disclosed is a method and a system for actuating a micromirror assembly.

### CROSS-REFERENCE TO RELATED APPLICATION

This application claims the benefit of U.S. provisional patent application Ser. No. 60/276,705, filed Mar. 15, 2001, the contents of which are hereby incorporated by reference.

### FIELD OF THE INVENTION

The present invention relates generally to the field of optical telecommunications, and more specifically to MEMS actuators for positioning optical mirrors and other elements.

### BACKGROUND OF THE INVENTION

The expansion of optical communication networks and their capacities for directing large amounts of data have created the need for compact, low-power optical switch subsystems. The optical switching systems of many of these networks, particularly those employing dense wavelength division multiplexing (DWDM), may benefit from the use of positionable mirror assemblies and associated optics to direct light from one selected fiber to another. All-optical switches may eliminate the need for large, expensive, power-hungry optical-electrical-optical (OEO) switch subsystems, but require high-resolution positioning systems for directing the light.

Mirror assemblies made from microelectromechanical systems (MEMS) manufacturing processes offer the potential for highly scalable, high-port-count optical switches. However, to achieve high port counts in a compact space, the mirrors typically are required to traverse large tilt angles in excess of ten degrees and be readily configured into one-dimensional and two-dimensional arrays.

In an attempt to meet these requirements, various types of MEMS actuators or microactuators have been pursued, including electrostatic, lateral comb, vertical comb, thermal, magnetic and piezoelectric actuators. These drive mechanisms are typically limited in their allowed displacements by structural and sacrificial layer thicknesses available in most MEMS processes. “Micro-Electro-Mechanical Optical Device” of U.S. Pat. No. 6,300,619 by Aksyuk et al. (Oct. 9, 2001), for example, describes an optical device with actuators that use a first and second pair of beams to support and elevate an optical element.

As the demands increase for optical devices with greater scalability and higher port counts, so does the need for various MEMS actuators that can generate larger displacements and tilt angles. An improvement in tilt angle may be significant to optical switch applications, in that the number of addressable ports is proportional to the square of the mirror tilt angle in some configurations.

A desirable microactuator system has multiaxis rotational control, as well as high-resolution deflection and scanning capability. One or more actuators may be needed, for example, to move or tilt thin micromachined mirrors to a desired angle.

The present invention overcomes the deficiencies and limitations of the actuators described above, addressing the need for an actuator system with large deflection capability and more specifically, with the ability to direct and redirect light through broader angles for applications such as optical switches with large port counts.

### SUMMARY OF THE INVENTION

A multistage actuator for steering a beam of light in accordance with the present invention is disclosed. The actuator may include a movable portion of an actuator drive mechanism, a first rotatable actuator member coupled to the movable portion of the actuator drive mechanism, and a second rotatable actuator member coupled to the first rotatable actuator member. The first rotatable actuator member and the second rotatable actuator member may traverse a first and second angle when the movable portion of the actuator drive mechanism is displaced. An optical element such as a micromirror may be coupled to the second rotatable actuator member or to subsequent stages. The actuator may include bond pads for applying drive voltages to the actuator drive mechanism.

The multistage actuator may be employed in an optical subassembly, containing a plurality of micromirror assemblies on a substrate where each micromirror assembly may include an optical mirror coupled to one or more actuators that are attached to the substrate. Each multistage rotatable actuator may include a movable portion of an actuator drive mechanism coupled to the substrate, a first rotatable actuator member coupled to the movable portion of the actuator drive mechanism, and a second rotatable actuator member coupled to the first rotatable actuator member.

A method and system for actuating the micromirror assemblies is disclosed, including steps and apparatus for applying a first control voltage to a movable portion of a multistage rotatable actuator, applying a second control voltage to a fixed portion of the multistage rotatable actuator, and positioning a micromirror coupled to one or more multistage rotatable actuators.

### BRIEF DESCRIPTION OF THE DRAWINGS

FIG. 1 illustrates a top view of one embodiment of an optical micromirror assembly, in accordance with the current invention;

FIG. 2 illustrates a side view of one embodiment of an optical micromirror assembly, in accordance with the current invention;

FIG. 3 illustrates a top view of one embodiment of a multistage actuator with a parallel-plate electrostatic drive mechanism, in accordance with the current invention;

FIG. 4 illustrates a top view of another embodiment of a multistage actuator with a parallel-plate electrostatic drive mechanism, in accordance with the current invention;

FIG. 5 illustrates a top view of another embodiment of a multistage actuator with a parallel-plate electrostatic drive mechanism, in accordance with the current invention;

FIG. 6 illustrates a top view of another embodiment of a multistage actuator with a parallel-plate electrostatic drive mechanism, in accordance with the current invention;

FIG. 7 illustrates a top view of one embodiment of a multistage actuator with an interdigitated electrostatic drive mechanism, in accordance with the current invention;

FIG. 8 illustrates a side view of one embodiment of a parallel-plate electrostatic drive mechanism, in accordance with the current invention;

FIG. 9 illustrates a side view of one embodiment of an interdigitated electrostatic drive mechanism, in accordance with the current invention;

FIG. 10 illustrates a top view of one embodiment of an optical subassembly for directing one or more beams of light, in accordance with the current invention; and

FIG. 11 is a flow diagram of one embodiment of a method for actuating a micromirror assembly, in accordance with the current invention.

### DETAILED DESCRIPTION OF THE INVENTION

The multilink or multistage actuator of the present invention may be used to raise three-dimensional structures such as a micromirror assembly from an essentially two-dimensional semiconductor substrate. One or more microactuators may position or tilt optical elements to a desired position and angle for steering one or more beams of light. Optical elements may include, for example, lenses, mirrors and gratings. The multistage actuators may produce large displacements well in excess of the sacrificial and structural layer thicknesses of many microelectromechanical system (MEMS) fabrication processes for forming all or a portion of the actuators.

The multistage actuator may provide a greater tilt angle and larger deflection than single-stage actuators by using a combination of actuator elements. The linked stages may amplify the deflection of an actuator drive mechanism to achieve greater tilt angles and positioning range with higher packing density.

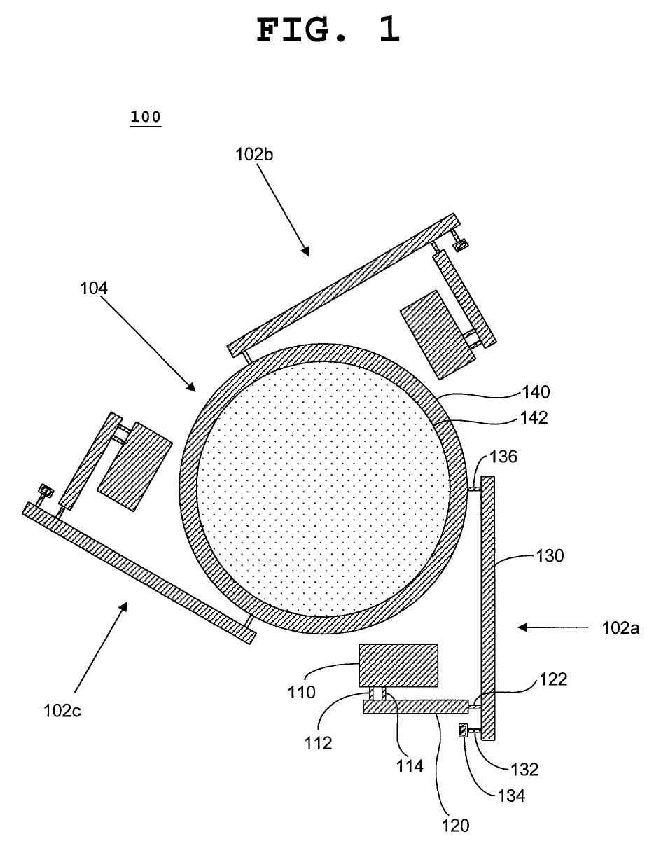

FIG. 1 shows a top view of one embodiment of a micromirror assembly, in accordance with the present invention at 100. An optical micromirror assembly 100 may include a plurality of multistage actuators 102a, 102b, and 102c, and an optical element or mirror element 104 coupled to the multistage actuators. Multistage actuators 102a, 102b, and 102c may be attached to a substrate. The multistage actuators may be used to position mirror element 104 in such a manner, for example, to redirect an incident beam of light off the micromirror. The micromirror or optical element may be lifted by each of the multistage actuators, and effectively rotated about one or two axes by varying the height of each micromirror attachment point. Although three multistage actuators are shown coupled to each optical element, one or more multistage actuators may be used to position the element. The micromirror assembly may be replicated on the substrate in a linear or rectangular configuration to form a micromirror assembly array or optical subassembly.

Multistage actuator 102a may be comprised of an actuator drive mechanism 110, a first-stage rotatable actuator member 120, and a second-stage rotatable actuator member or actuator arm 130. First-stage rotatable actuator member 120 may be coupled to the actuator drive mechanism with one or more hinges 112, 114. First-stage rotatable actuator member 120 may be coupled to the substrate with one or more substrate hinges. Second-stage actuator arm 130 may be coupled to first-stage rotatable actuator member 120 with a coupling hinge 122. Second-stage actuator arm 130 may be coupled to the substrate with a substrate hinge 132 and a substrate anchor 134 attached to the substrate. First-stage rotatable actuator member 120 may mechanically amplify motions or displacements of actuator drive mechanism 110, and second-stage actuator arm 130 may mechanically amplify motions of first-stage rotatable actuator member 120 to move mirror element 104. A small motion of a movable portion of the actuator drive mechanism may result in a rotation of first-stage rotatable actuator member 120 and a rotation of second-stage actuator arm 130, with a much larger motion at the end of second-stage actuator arm 130. A ratio of a displacement of at least a portion of first-stage rotatable actuator member 120 to the displacement of the movable portion of actuator drive mechanism 110 may be greater than one. A ratio of less than one may be used in cases where more torque is desired. A ratio of a displacement of at least a portion of second-stage rotatable actuator member or actuator arm 130 to a displacement of a movable portion of actuator drive mechanism 110 may be greater than two, and may exceed forty.

In one currently preferred embodiment, a triad of multistage actuators 102a, 102b, and 102c may be used to position and tilt mirror element 104 three-dimensionally.

First-stage rotatable actuator member 120 may be coupled to second-stage actuator arm 130 with a coupling hinge 122, which may be a relatively short, straight torsional hinge segment. Alternatively, coupling hinge 122 may be comprised of a series of torsional hinge and flexural segments of varying width and length.

Second-stage actuator arm 130 may be coupled to mirror element 104 with a micromirror hinge 136. The micromirror hinge may be a relatively short, straight torsional hinge segment. Alternatively, the micromirror hinge may be comprised of a series of torsional hinge and/or flexural segments that allow rotation and bending of the hinge. Elevation changes of an end of second-stage actuator arm 130 with micromirror hinge 136 may allow positioning of mirror element 104.

Mirror element 104 may be comprised of a micromirror support 140 and an optical reflector 142. Optical reflector 142 may be comprised of gold, aluminum, platinum, any suitable metal, a combination of metals, or a dielectric stack for reflecting and redirecting a beam of light. Optical reflector 142 may be formed on micromirror support 140. Micromirror support 140 may be formed from a layer of polycrystalline silicon, single crystal silicon, or any suitable micromirror support material.

First-stage rotatable actuator member 120 and second-stage actuator arm 130 may be formed from a layer of single polycrystalline silicon, single crystal silicon, or any suitable actuator arm material. Rotatable actuator members 120, 130 and micromirror support 140 may be formed from a single layer of polycrystalline silicon, single crystal silicon, or any suitable actuator arm material. Similarly, micromirror hinge 136, coupling hinge 122, and hinges 112, 114 may be formed from the same layer. A movable portion of the actuator drive mechanism may also be made from the same layer. Although it may be desirable to form various portions of the actuator from the same layer of material to benefit from uniform thickness and locally uniform sidewall profiles, additional layers and materials may be used in lieu of or to augment the structural layer.

Portions or all of the multistage actuators and micromirrors may be fabricated using a micromachining process with one or more free-standing structural layers, such as a multi-user MEMS process that allows one or many devices to be fabricated simultaneously on a single wafer. Portions or all of the multistage actuators and micromirrors may be fabricated using a micromachining process utilizing silicon-on-insulator (SOI) substrates with one or more sacrificial and structural layers. A surface micromachining process, a bulk micromachining process or some combination of the two may be used to fabricate the multistage actuators and micromirrors. Each torsional spring, actuator arm or mirror support may be fabricated, for example, using a deposited polysilicon thin film, an active silicon layer or device layer of an SOI wafer, or a single crystal silicon substrate.

Mirror element 104 exemplifies one application of the present invention where a beam of light may be scanned or switched with the micromirrors. Other elements may be substituted for the mirror, such as a microlens, a grating, or any other optical element. The microactuators may be used to position other non-optical elements.

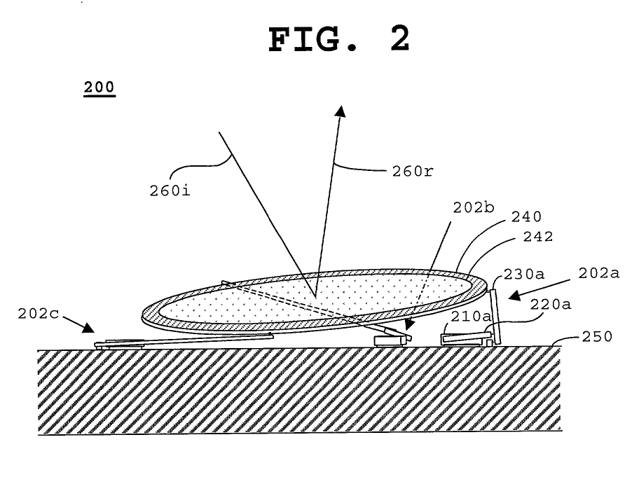

FIG. 2 shows a side view of one embodiment of an optical micromirror assembly, in accordance with the present invention at 200. Micromirror assembly 200 may be one of a plurality of micromirror assemblies on a substrate, which may be part of a larger optical subassembly for steering at least one beam of light. Each micromirror assembly may comprise an optical mirror operably coupled to a plurality of multistage actuators attached to the substrate.

In one currently preferred embodiment, micromirror assembly 200 may comprise a triad of multistage actuators 202a, 202b, 202c, a micromirror support 240, an optical reflector 242, and a substrate 250. Substrate 250 may comprise a portion of a silicon wafer, a typical semiconductor material used in the manufacture of integrated circuits. The silicon wafer may be sawed or diced to provide optical subassemblies with one or more micromirrors and their corresponding actuators on a die or strip.

Each multistage actuator 202a, 202b, and 202c may be attached to the surface of substrate 250. Exemplary of the other two multistage actuators, multistage actuator 202a may have an actuator drive mechanism 210a coupled to first-stage rotatable actuator member 220a, which may be coupled to second-stage rotatable actuator member or actuator arm 230a. Second-stage actuator arm 230a, as well as second-stage actuator arms of multistage actuator 202b and 202c, may be coupled to micromirror support 240 that secures optical reflector 242. Multistage actuators 202a, 202b and 202c, in conjunction with first actuator rotatable members, may be utilized to rotate and lift the ends of the actuator arms. The first and second actuator rotatable members may work together to position the micromirror and control the angles of mirror tilt about two orthogonal axes.

For multistage actuator 202a, a ratio of a displacement of at least a portion of first-stage rotatable actuator member 220a to a displacement of a movable portion of actuator drive mechanism 210a may be greater than one. The mechanical amplification may be further increased with second-stage actuator arm 230a, where a ratio of a displacement of at least a portion of second-stage rotatable actuator member or actuator arm 230a to a displacement of a movable portion of actuator drive mechanism 210 may be greater than two, and in some cases greater than forty. Like multistage actuator 202a, multistage actuators 202b and 202c may have similar ratios of displacement.

An incident light beam 260i directed onto optical reflector 242 may be redirected as a reflected light beam 260r according to the position and tilt of the micromirror, as positioned by the multistage actuators.

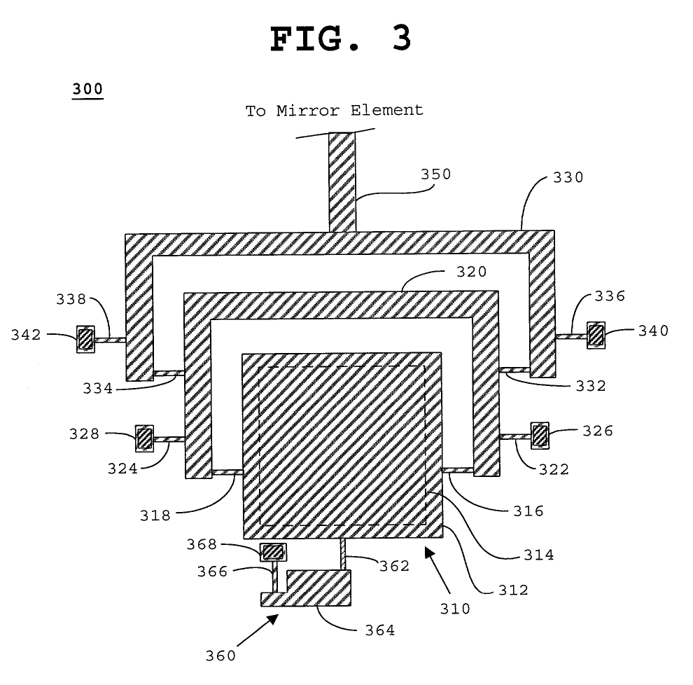

FIG. 3 shows a top view of one embodiment of a multistage actuator with a parallel-plate electrostatic drive mechanism, in accordance with the present invention at 300. Multistage actuator 300 may be employed to lift, rotate and position a micromirror element as part of a micromirror assembly.

Multistage actuator 300 may include a parallel-plate electrostatic drive mechanism 310, a first-stage rotatable actuator member 320; a second-stage rotatable actuator member 330 that may be extended by an actuator arm 350, and a balancing spring 360. An optical mirror element may be coupled to one end of actuator arm 350. An optical mirror element or other element may be connected to one end of actuator arm 350, and may be lifted, rotated or positioned by one or more multistage actuators.

Parallel-plate electrostatic drive mechanism 310 may include an upper electrode or movable portion 312 of the actuator drive mechanism and a lower electrode or fixed portion 314 of the actuator drive mechanism. Movable portion 312 of the actuator drive mechanism may comprise a plate positioned above fixed portion 314 of the actuator drive mechanism. Movable portion 312 and fixed portion 314 may form two electrodes of a parallel-plate capacitor. When voltages are applied across the movable portion and the fixed portion, the movable portion may be electrostatically attracted to the fixed portion. The displacement of movable portion 312 may depend on the voltage difference between the two electrodes, the gap between the electrodes, and the mechanical support mechanism for the movable portion. The lower electrode or fixed portion 314 of parallel-plate electrostatic drive mechanism 310 may correspond to a doped region in the underlying substrate. The lower electrode or fixed portion 314 of parallel-plate electrostatic drive mechanism 310 may be formed from a metal or semiconductor layer deposited on an electrically insulative layer on the substrate. Movable portion 312 of parallel-plate electrostatic drive mechanism 310 may be coupled to first-stage rotatable actuator member 320.

Actuator hinges 316, 318 may be used to couple first-stage rotatable actuator member 320 to movable portion 312 of the parallel-plate electrostatic drive. Actuator hinges 316, 318 may include torsional hinges with one segment, or a series of segments connecting first-stage rotatable actuator member 320 with movable portion 312 in a compliant manner. Actuator hinges may comprise a relatively short, straight torsional hinge. Alternatively, actuator hinges may comprise a series of straight, torsional and/or flexural segments that allow rotation and bending of the hinge.

First-stage rotatable actuator member 320 may be coupled to the substrate with one or more substrate hinges 322, 324. Substrate hinges may comprise a relatively short, straight torsional hinge. Alternatively, substrate hinges may comprise a series of straight, torsional and/or flexural segments that allow rotation and bending of the hinge. Substrate hinges 322, 324 may be connected to the substrate with substrate anchors 326, 328. Substrate anchors 326, 328 may be attached to the surface of the substrate.

A second-stage rotatable actuator member 330 may be coupled to first-stage rotatable actuator member 320 with one or more coupling hinges 332, 334. Two or more substrate hinges 336, 338 may couple second-stage rotatable actuator member 330 to substrate anchors 340, 342, respectively, which may be attached to a substrate. Actuator arm 350 may extend from second-stage rotatable actuator member 330.

Actuator arm 350 may lift when second-stage rotatable actuator member 330 is rotated about substrate hinges 336, 338. Second-stage rotatable actuator member 330 may be lifted when first-stage rotatable actuator member 320 is rotated about substrate hinges 322, 324 as movable portion 312 of the actuator drive mechanism is deflected towards the substrate, due to forces applied to the rotatable actuator member by actuator hinges 316, 318.

When movable portion 312 of the actuator drive mechanism is displaced and effects rotations of first-stage rotatable actuator member 320, the movable portion itself may rotate unduly. Undue rotations of the movable portion may cause the electrode to prematurely snap towards the substrate due to the pull-in effect, leading to lack of control of actuator motion and potentially to sticking of movable portion 312 to the substrate. A method of providing a suitable countertorque to mitigate rotation of movable portion 312 may be obtained with balancing spring 360. Balancing spring 360 may provide a countertorque to movable portion 312 to maintain it nominally parallel to the substrate when actuated. Balancing spring 360 may be used to ensure that movable portion 312 of the actuator drive mechanism is guided and maintained nominally parallel to the surface of the substrate. Because of balancing spring 360, the entire movable portion 312 may be displaced normal or perpendicular to the substrate, maximizing the available capacitance change before pull-in is reached, and thus maximizing the output force.

Balancing spring 360 may be coupled between movable portion 312 of the actuator drive mechanism and the substrate. Balancing spring 360 may consist of two torsional hinges 362, 366 and a nominally rigid connecting member 364. Torsional hinge 362 may be connected between movable portion 312 and nominally rigid connecting member 364. Torsional hinges may comprise a relatively short, straight torsional hinge. Alternatively, the torsional hinges may comprise a series of straight, torsional and/or flexural segments that allow rotation and bending of the hinge. Torsional hinge 366 may be connected between nominally rigid connecting member 364 and the substrate with substrate anchor 368.

As movable portion 312 of the actuator drive mechanism moves toward the fixed portion 314 of the electrostatic drive mechanism, a force may be applied to actuator hinges 316, 318, causing first-stage rotatable actuator member 320 to rotate through a first angle, thereby causing second-stage rotatable actuator member 330 along with actuator arm 350 to rotate through a second angle. When the actuator members and arms are rotated, balancing spring 360 may maintain movable portion 312 of the actuator drive mechanism nominally parallel to the substrate.

The displacement of second-stage rotatable actuator member 330 and actuator arm 350 may produce deflections that may be greater than the sacrificial layer thickness of the microfabrication process. The same may be true for first-stage rotatable actuator member 320. The sacrificial layer thickness may determine the gap between the fixed and movable electrodes, and in many applications deflections much larger than the gap are desired.

Another feature of the multistage actuator is that movable portion 312 of the actuator drive mechanism, first-stage rotatable actuator member 320, and second-stage rotatable actuator member 330 may be formed from one layer such as single crystal silicon or deposited polycrystalline silicon available in many micromachining processes. Additional elements of various torsional members or hinges 316, 318, 322, 324, 332, 334, 336, 338, 362, 366, as well as substrate anchors 326, 328, 340, 342 and balancing spring 360, also may be formed from the same layer, although they may be formed from more than one layer or from another layer available in the process.

In some embodiments of the present invention, the torsional hinges may be dimensioned with essentially identical lengths and widths to provide some immunity to sidewall etch profile variations and etch undercutting from the micromachining process, such that the actuation capability is largely insensitive to etch variations of the microfabrication process. Flexural members and other portions of the actuators may benefit from similar dimensioning considerations.

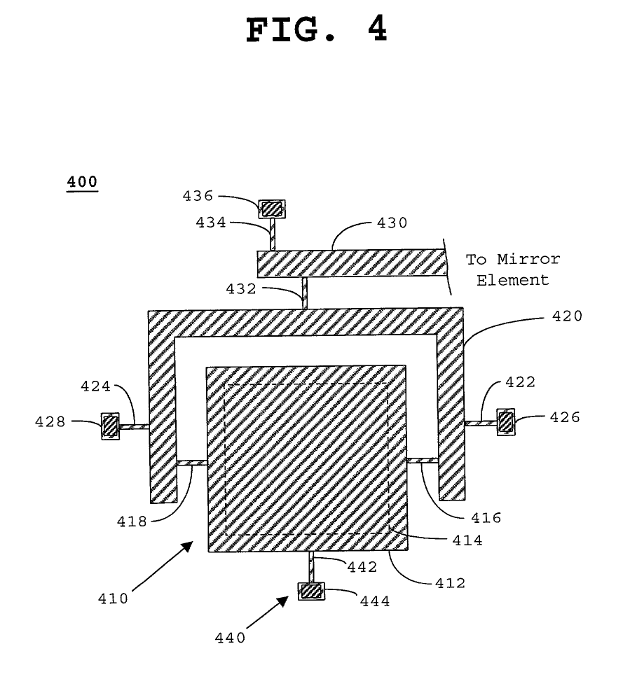

FIG. 4 shows a top view of another embodiment of a multistage actuator, in accordance with the present invention at 400. A second rotatable actuator member may be coupled at essentially 90 degrees or nominally orthogonal to a first rotatable actuator member, and attached to the substrate with one or more substrate hinges.

Multistage actuator 400 may include a rotor or movable portion 412 and a stator or fixed portion 414 of a parallel-plate electrostatic drive mechanism 410; a first-stage rotatable actuator member 420 coupled to movable portion 412 of parallel-plate electrostatic drive mechanism 410; two actuator hinges 416, 418 coupled to first-stage rotatable actuator member 420; at least two substrate hinges 422, 424 coupled to first-stage rotatable actuator member 420 and at least two substrate anchors 426, 428 respectively; a second-stage rotatable actuator member or actuator arm 430 coupled to first-stage rotatable actuator member 420 by a coupling hinge 432; and a substrate hinge 434 coupled to second-stage actuator arm 430 and a substrate anchor 436. A torsional member or balancing spring 440 may be coupled to movable portion 412 of parallel-plate electrostatic drive mechanism 410 and a substrate anchor 444. Substrate anchors 426, 428, 436, 444 may be attached to a substrate.

When electrostatic force is generated by movable portion 412 of the electrostatic drive mechanism, actuator hinges 416, 418 may couple the force into rotations of first-stage rotatable actuator member 420. Flexural member 442 of balancing spring 440 may be used to ensure that the movable portion 412 of the actuator drive mechanism remains parallel to the surface of the substrate during actuation.

The actuator drive mechanism may rotate first-stage rotatable actuator member 420, which in turn may be used to rotate or displace second-stage rotatable actuator member or actuator arm 430, causing a micromirror element or other element attached to second-stage actuator arm 430 to be positioned. The element attachment point may be rotated and deflected bidirectionally when the movable portion 412 of the electrostatic drive mechanism is driven bidirectionally. An optical element or other element attached to second-stage actuator arm 430 may be lifted and tilted about one axis without the need for a second actuator.

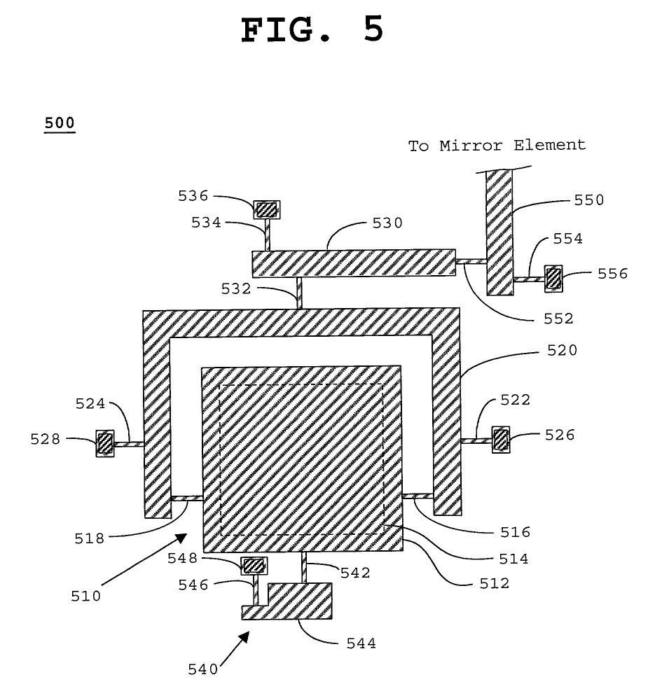

FIG. 5 shows a top view of another embodiment of a multistage actuator, in accordance with the present invention at 500. In this embodiment, the actuator may comprise three stages: a first-stage rotatable actuator member or actuator arm, a second-stage actuator arm, and a third-stage actuator arm. Actuator systems with more than two links or stages may result in increased range of motion, while effectively utilizing space on the substrate. A micromirror or an optical element may be coupled to the third-stage rotatable actuator member.

Multistage actuator 500 may include a movable portion 512 and a rigid or fixed portion 514 of a parallel-plate electrostatic drive mechanism 510; a first-stage rotatable actuator member 520 coupled to movable portion 512 of parallel-plate electrostatic drive mechanism 510; two actuator hinges 516, 518 coupled to first-stage rotatable actuator member 520; at least two substrate hinges 522, 524 coupled to first-stage rotatable actuator member 520 and at least two substrate anchors 526, 528 respectively; a second-stage rotatable actuator member or actuator arm 530 coupled to first-stage rotatable actuator member 520 by a coupling hinge 532; a substrate hinge 534 coupled to second-stage actuator arm 530 and a substrate anchor 536; a third-stage rotatable actuator member or actuator arm 550 coupled to second-stage actuator arm 530 by a coupling hinge 552; and a substrate hinge 554 coupled to third-stage actuator arm 550 and a substrate anchor 556. A balancing spring 540 may be coupled between movable portion 512 of the actuator drive mechanism and the substrate. Balancing spring 540 may consist of two torsional hinges 542, 546 and a nominally rigid connecting member 544. Torsional hinge 542 may be connected between movable portion 512 and nominally rigid connecting member 544. Torsional hinge 546 may be connected between nominally rigid connecting member 544 and the substrate with substrate anchor 548.

When electrostatic force is generated by movable portion 512 of the electrostatic drive mechanism, actuator hinges 516, 518 may couple the force into displacements or rotations of first-stage rotatable actuator member 520. First-stage rotatable actuator member 520 may be rotated to displace or rotate second-stage actuator arm 530, which in turn may rotate or displace third-stage actuator arm 550, causing a micromirror element, optical element, or other element attached to third-stage actuator arm 550 to be positioned. The mirror attachment point may be deflected or rotated bidirectionally when movable portion 512 of the actuator drive mechanism is driven bidirectionally.

FIG. 6 shows a top view of another embodiment of a multistage actuator with a parallel-plate electrostatic drive mechanism, in accordance with the present invention at 600. In this embodiment, the actuator comprises two coupled rotatable arms to position a micromirror or other element and a rotating member to provide countertorque for balancing the electrostatic drive mechanism.

Multistage actuator 600 may include a movable portion 612 and a fixed portion 614 of a parallel-plate electrostatic drive mechanism 610; a rotatable actuator member 620 coupled to movable portion 612 of parallel-plate electrostatic drive mechanism 610; two actuator hinges 616, 618 coupled to rotatable actuator member 620; at least two substrate hinges 622, 624 coupled to rotatable actuator member 620 and at least two substrate anchors 626, 628 respectively; a first-stage rotatable actuator member or actuator arm 630 coupled to movable portion 612 of the electrostatic drive mechanism by a torsional hinge 632; a substrate hinge 634 coupled to first-stage actuator arm 630 and a substrate anchor 636; a coupling hinge 642 that couples first-stage actuator arm 630 to a second-stage rotatable actuator member or actuator arm 640; and a substrate hinge 644 that couples second-stage actuator arm 640 and a substrate anchor 646. A micromirror, optical element, or other non-optical element may be coupled to second-stage actuator arm 640 for positioning by the multistage actuator.

When electrostatic force is generated by movable portion 612 of the electrostatic drive mechanism, torsional hinge 632 may induce rotation of first-stage actuator arm 630. First-stage actuator arm 630 may be rotated to displace second-stage actuator arm 640, causing a micromirror element or other element coupled to second-stage actuator arm 640 to be rotated, displaced or positioned. The element attachment point may be deflected bidirectionally when movable portion 612 of the electrostatic drive mechanism is driven bidirectionally.

Rotatable actuator member 620 may provide a countertorque to movable portion 612 to help maintain movable portion 612 nominally parallel to the substrate when actuated.

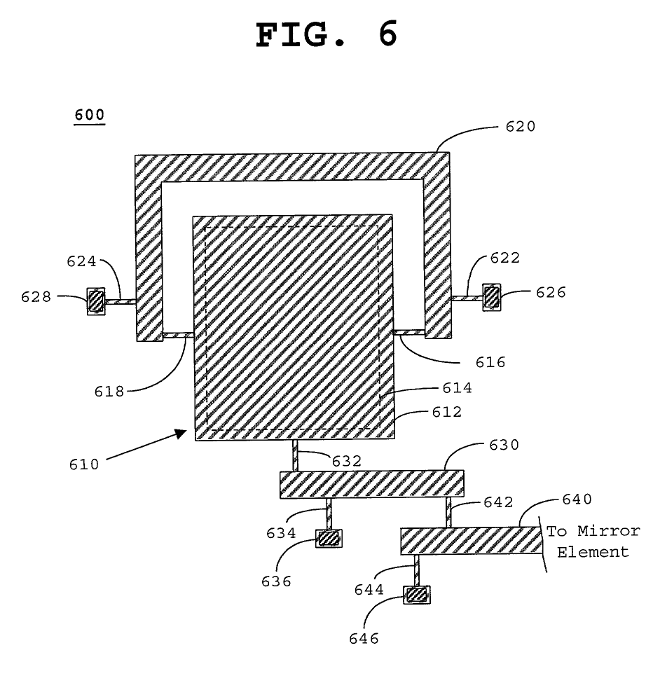

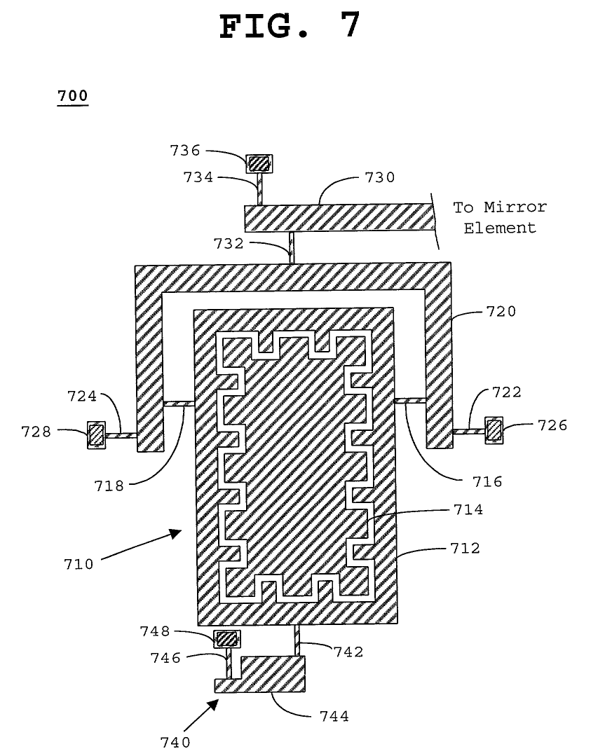

FIG. 7 shows a top view of one embodiment of a multistage actuator with an interdigitated electrostatic drive mechanism, in accordance with the present invention at 700. The interdigitated electrostatic drive mechanism may also be referred to as a comb drive mechanism or a vertical comb drive. In one preferred embodiment, the interdigitated electrostatic drive mechanism may comprise a number of interleaved fingers for deflecting a movable portion of the actuator drive mechanism in an upwards direction, away from the substrate, with applied voltage. The limited deflection range of an electrostatic drive may be converted to a large deflection at the mirror coupling point. This embodiment may exploit the limited travel range of an interdigitated electrostatic drive, while maximizing the travel range at a point where a micromirror or other element is attached.

Multistage actuator 700 with interdigitated electrostatic drive mechanism 710 may include a movable portion 712 and a fixed portion 714 of interdigitated electrostatic drive mechanism 710, a first-stage rotatable actuator member 720, and a second-stage rotatable actuator member or actuator arm 730 coupled to first-stage rotatable actuator member 720. A balancing spring 740 may be coupled to the movable portion 712 of the electrostatic drive mechanism. An optical mirror element or other type of element may be coupled near one end of second-stage actuator arm 730.

Multistage actuator 700 may include movable portion 712 as one electrode and fixed portion 714 as a second electrode of interdigitated electrostatic drive mechanism 710; at least two actuator hinges 716, 718; a first-stage rotatable actuator member 720 coupled to the substrate with at least two substrate hinges 722, 724 attached to substrate anchors 726, 728, respectively; a balancing spring 740 comprising a nominally rigid connecting member 744, a torsional hinge 742 and a torsional hinge 746 attached to substrate anchor 748; a second-stage actuator arm 730 coupled to first-stage rotatable actuator member 720 by a coupling hinge 732; and a substrate hinge 734 that couples second-stage actuator arm 730 to a substrate anchor 736. The end of second-stage actuator arm 730 may be coupled to a mirror element.

Actuator hinges 716, 718 may couple the movable portion 712 of interdigitated electrostatic drive mechanism 710 to first-stage rotatable actuator member 720. First-stage rotatable actuator member 720 may be coupled to the substrate with substrate hinges 722, 724 by use of substrate anchors 726, 728, respectively.

Balancing spring 740, which is coupled to movable portion 712 of the drive, may be used to ensure that the movable portion of the actuator drive mechanism is maintained nominally parallel to the surface of the substrate during activation.

Movable portion 712 of interdigitated electrostatic drive mechanism 710 may consist of an array of fingers extending from at least one side. Interleaved with each set of fingers on the movable portion may be an array of fingers of the fixed portion of the actuator drive mechanism. Application of control voltages to the fixed and movable portions of the interdigitated electrostatic drive mechanism may allow the movable portion 712 to be directed up, down, or maintained at a desired location. As the movable portion 712 of the electrostatic drive mechanism moves with respect to fixed portion 714 of the interdigitated drive, a force may be applied to actuator hinges 716, 718, causing first-stage rotatable actuator member 720 to rotate through an angle and to mechanically amplify the motion of the movable portion 712 of the actuator drive mechanism. In turn, first-stage rotatable actuator member 720 may cause second-stage actuator arm 730 to rotate and further amplify the motion of movable portion 712 of the interdigitated drive mechanism, thus lifting, rotating, or repositioning a micromirror or other element coupled near the end of second-stage actuator arm 730.

An interdigitated electrostatic drive actuator may generate more force by increasing the number of fingers, increasing the length of the interdigitated fingers, increasing the peripheral area of the drive electrode, and decreasing the gap between the fingers. Increasing the drive voltage may increase the generated force. Movable portion 712 of the interdigitated electrostatic drive actuator may move up or down normal or perpendicular to the substrate as a control voltage is applied to the pairs of fingers.

While the illustration shows an interdigitated electrostatic drive mechanism with its movable portion 712 on the outer perimeter of the drive, movable portion 712 may be configured as an inner portion of the drive mechanism with the fixed portion of the drive on the outer perimeter. Multiple interdigitated electrostatic drive mechanisms may be used in parallel to increase the actuation force and lifting capability of the actuator arms.

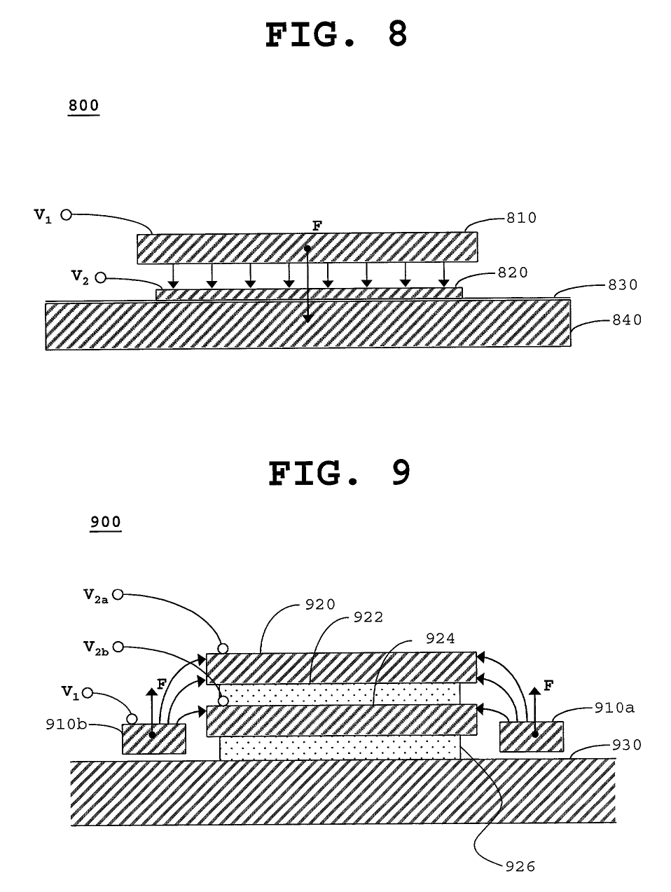

FIG. 8 shows a side view of one embodiment of a parallel-plate electrostatic drive mechanism, in accordance with the present invention at 800. The figure also shows a first drive voltage VI applied to the movable portion of the actuator drive mechanism and a second drive voltage V2 applied to a fixed portion of the actuator drive mechanism.

Parallel-plate electrostatic drive mechanism 800 may include an upper electrode or movable portion 810 of the electrostatic drive mechanism, a lower electrode or fixed portion 820 of the electrostatic drive mechanism, an insulating layer or dielectric layer 830, and a substrate 840. The fixed portion 820 of the electrostatic drive mechanism may be electrically isolated from substrate 840 by an insulating layer or dielectric layer 830. Dielectric layer 830 may comprise, for example, a layer of silicon dioxide or silicon nitride. Alternatively, fixed portion 820 of the electrostatic drive mechanism may be formed integrally with the substrate by localized doping of the semiconductor substrate. The upper electrode or movable portion 810 may be separated from the lower electrode or fixed portion 820 by a gap.

A downward, attractive force F may be generated by coulombic attraction between movable portion 810 and fixed portion 820 of the parallel-plate electrostatic drive mechanism when voltages V1 and V2 are applied across the electrodes. An electric field may be generated between the electrodes, generating a force that is a function of the voltage difference and the gap. The force may displace movable portion 810 towards fixed portion 820. Restoring forces are applied by torsional springs and flexural members attached to movable portion 810 not shown in the illustration. As a capacitive structure, the electrostatic actuator may increase its capacitance when the gap between the electrodes is reduced.

FIG. 9 shows a side view of one embodiment of an interdigitated electrostatic drive mechanism, in accordance with the present invention at 900. Interdigitated electrostatic drive mechanism 900 may comprise a movable portion 910a, 910b of the electrostatic drive mechanism, a fixed portion 920, 924 of the electrostatic drive mechanism, and a substrate 930. Torsional hinges and flexural members not shown in the illustration may support movable portion 910a, 910b of the electrostatic drive mechanism. Movable portions 910a, 910b of the electrostatic drive mechanism may be electrically connected to each other. Fixed portions 920, 924 may be electrically isolated from the substrate with dielectrics 922, 926. Electrical isolation from the substrate may be achieved with dielectric 926. Electrical isolation from the substrate may be achieved with dielectric 926 in combination with dielectric 922. The dielectric layers may allow voltage to be placed across the electrodes, and may provide physical space or height elevation between the electrodes and the substrate.

A first voltage V1 may be applied to a first electrode or movable portion 910a, 910b of the interdigitated electrostatic drive mechanism, and a second voltage V2 may be applied to a second electrode or fixed portion 920 of the interdigitated electrostatic drive mechanism. The second voltage V2 may be applied to second electrode or fixed portion 924. Voltage V2 may be simultaneously applied to fixed portion 920 and 924. Alternatively, a voltage V2a may be applied to fixed portion 920 and a voltage V2b may be applied to fixed portion 924. A substrate voltage may be applied to substrate 930. The substrate voltage may be set equal to the voltage applied to movable portion 910a, 910b, or both substrate 930 and movable portion 910a, 910b may be set equal to a ground potential.

An upward force F may be generated by coulombic attraction between movable portion 910a, 910b and fixed portion 920 of the interdigitated electrostatic drive mechanism when voltages V1 and V2 are applied to the electrodes. An electric field may be generated between the electrodes, generating a force that may be a function of the voltage difference and the effective gap. The force may displace movable portion 910a, 910b relative to fixed portion 920, 924, although flexural members and torsional hinges supporting movable portion 910a, 910b and structural symmetry may constrain the movement of movable portion 910a, 910b to a direction essentially perpendicular to substrate 930. Movable portion 910a, 910b may lift from substrate 930 with increasing voltage difference applied to the electrodes. Movable portion 910a, 910b may lift to a level nearly planar with fixed portion 920, due to curvature of electric field lines and upward components of force not illustrated in the figure. Torsional springs and flexural members (not shown) that are attached to movable portion 910a, 910b may generate restoring forces when movable portion 910a, 910b is displaced.

The interdigitated electrostatic drive actuator may generate more force by utilizing a series of interdigitated fingers and by increasing the amount of interdigitated finger overlap between movable portion 910a, 910b and fixed portion 920, 924. The generated force may increase as larger drive voltages are applied across the gap between the fingers. Narrowing the gap between the electrodes or increasing the number of fingers may increase the capacitance and generated force. Increasing the drive voltage may also increase the generated force.

Although the illustration shows a tiered structure of fingers and dielectric, the interdigitated configuration may have one or more layers of fingers and one or more layers of dielectric. A conductive ground plane, not shown in the figure, may be included on the surface of substrate 930 underneath movable portion 910a, 910b of the interdigitated electrostatic drive mechanism. The ground plane may be electrically isolated from the substrate by a dielectric layer, also not shown in the figure. The potential of the ground plane may be set the same as the potential of movable portion 910a, 910b.

An electrostatic drive mechanism combining the attractive features of the parallel-plate electrostatic drive mechanism and lifting features of the interdigitated electrostatic drive mechanism may be configured.

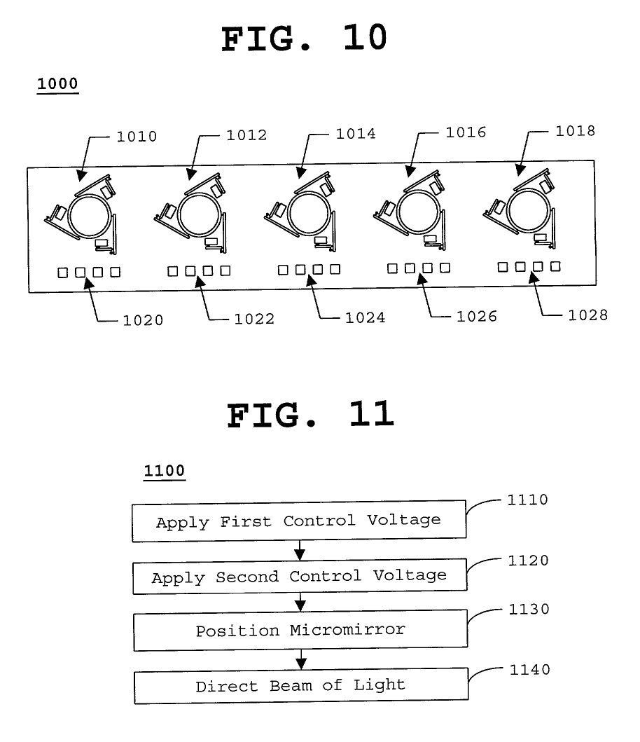

FIG. 10 shows a top view of one embodiment of an optical subassembly for directing one or more beams of light, in accordance with the present invention at 1000. Optical subassembly 1000 may include a plurality of micromirror assemblies 1010, 1012, 1014, 1016, 1018 on a substrate.

Each micromirror assembly may include an optical mirror operably coupled to a plurality of multistage actuators attached to the substrate. Each multistage actuator may include a first-stage rotatable actuator member or actuator arm, a second-stage rotatable actuator member or actuator arm, an optional third-stage rotatable actuator member or actuator arm, and a movable portion of an actuator drive mechanism. The micromirror assembly may include a balancing spring or rotatable actuator member for providing countertorque and stability. The first-stage rotatable actuator member may be coupled to the substrate and the movable portion of the electrostatic drive mechanism. A second-stage actuator arm may be coupled to the first-stage actuator member and to an optical mirror or other element. The second-stage actuator arm may be coupled to the substrate with one or more substrate hinges. When an optional third-stage actuator arm is used, the second stage actuator arm may be coupled to the third-stage actuator arm, which in turn may be coupled to an optical mirror. The third-stage actuator arm may be coupled to the substrate with one or more substrate hinges. A balancing spring may be coupled between the movable portion of the actuator drive mechanism and the substrate. Each optical mirror may be coupled to one or more multistage actuators. The optical mirror may be coupled to a triad of multistage actuators. The multistage actuators may position and rotate the micromirror. The positioned micromirror may direct a beam of light incident on the micromirror towards a desired direction. Although an array of five micromirror assemblies is illustrated, linear or rectangular arrays may be configured with fewer or many more micromirror assemblies.

Optical subassembly 1000 may include bond pads for applying voltages to actuate each multistage actuator. A micromirror coupled to each multistage actuator may be positioned by applying appropriate drive voltages to sets of bonding pads 1020, 1022, 1024, 1026, 1028 associated with micromirror assemblies 1010, 1012, 1014, 1016, 1018, respectively. Four pads associated with each multistage actuator are illustrated for applying a first control voltage to a movable portion of the multistage actuator, and a second control voltage to a fixed portion of the multistage actuator such that a micromirror or other element coupled to the multistage actuator may be rotated, deflected, or positioned. In the triad configuration shown, the substrate or ground plane voltage may be applied in common to each actuator in the triad. Alternatively, the substrate or ground plane voltage may be applied in common to all actuators in the subassembly, further reducing the number of pads and bonding wires attached to the pads.

Although direct application of drive voltages for the multistage actuators using bond pads is illustrated in optical subassembly 1000, other approaches may be used to provide the desired voltages. For example, integrated circuitry may be cofabricated on the semiconductor substrate, using multiplexers, voltage amplifiers, charge amplifiers, digital-to-analog converters, analog-to-digital converters, serial data converters, digital signal processors, or any suitable circuit or set of circuit elements to actuate the multistage actuators.

FIG. 11 shows a flow diagram of one embodiment of a method for actuating a micromirror assembly, in accordance with the present invention at 1100.

A first control voltage may be applied to the movable portion of the actuator drive mechanism, as seen at block 1110. A second control voltage may be applied to the fixed portion of the drive mechanism, as seen at block 1120. By use of actuator arms coupled to the multistage actuators, the micromirror or other element may be lifted, rotated, or positioned, as seen at block 1130. An incident beam of light may be steered or directed by the positioned mirror towards a desired direction, as seen at block 1140.

Even though the presently preferred embodiments illustrate the use of electrostatic drive mechanisms, the implementation of the current invention may include, but not be limited to other actuator drive mechanisms such as a thermal drive mechanism, a piezoelectric drive mechanism, and a magnetic drive mechanism. The thermal drive mechanism may convert, for example, an applied voltage or current into heat, thereby expanding a portion of the actuator drive mechanism, which may be coupled into rotatable actuator members and associated actuator arms to position a mirror element. A piezoelectric drive mechanism may convert, for example, an applied voltage into expanding or bending a portion of the actuator drive mechanism, which may be coupled into rotatable actuator members and associated actuator arms to position the micromirror. A magnetic drive mechanism may convert, for example, an applied voltage or current into a magnetic field for driving a rotatable actuator member and associated actuator arms to position the micromirror.

While the current invention has been presented in the context of optical beam steering, scanning and switch applications, the multistage actuators may be used in other fields such as microbiology, microfluidics, and micromechanics, where an actuator may be used to manipulate or position an object or element other than a micromirror.

Although the present invention has been described in accordance with the embodiments shown, one of ordinary skill in the art may recognize variations to the embodiments, and those variations would be within the spirit and scope of the present invention. For example, the shape, number and composition of the multistage actuators and micromirrors may be altered as desired without departing from the basic function of the elements. Dimensional changes may be made to enhance or optimize other parameters such as force generation, voltage requirements, power consumption, speed of actuation, mirror-tilt angle, actuator angle or vertical height capability. Alterations to the process such as the number of structural and sacrificial layers, film thicknesses, doping levels, dielectric layer constituency, conductive layer characteristics, substrate type, film deposition parameters, and etching characteristics may be made without departing from the basic function of the elements. Any of the torsional hinges, mirror hinges, actuator hinges, substrate hinges, coupling hinges and balancing springs may be configured as a single, short segment or as a combination of one or more torsional and flexural segments. One actuator drive mechanism may be coupled to more than one rotatable actuator member. An actuator drive mechanism may be coupled to a second or additional stage in addition to the first stage. A second actuator drive mechanism may be coupled to a second stage or additional stages. More than one actuator may be coupled to the first or additional stages. Optical elements or non-optical elements may be connected to the first stage or to subsequent stages. Elements of one embodiment may be configured with elements of another embodiment, such as three stages of actuation mechanisms with a vertical comb drive. Lateral motion may be combined with rotating and vertical motion. Accordingly, many modifications may be made by one of ordinary skill in the art without departing from the spirit and scope of the appended claims.

What is claimed is:

1. An actuator for steering a beam of light comprising:
a movable portion of an actuator drive mechanism;
a first rotatable actuator member coupled to the movable portion of the actuator drive mechanism; and
a second rotatable actuator member coupled to the first rotatable actuator member, wherein the first rotatable actuator member traverses a first angle and the second rotatable actuator member traverses a second angle when the movable portion of the actuator drive mechanism is displaced.

2. The actuator of claim 1 wherein the substrate comprises at least a portion of a silicon wafer.

3. The actuator of claim 1 wherein the first rotatable actuator member is coupled to the substrate with at least one substrate hinge.

4. The actuator of claim 1 wherein the second rotatable actuator member is coupled to the substrate with at least one substrate hinge.

5. The actuator of claim 1 wherein the second rotatable actuator member is coupled nominally orthogonal to the first rotatable actuator member.

6. The actuator of claim 1 wherein the movable portion of the actuator drive mechanism, the first rotatable actuator member, and the second rotatable actuator member are formed from a layer of single crystal silicon.

7. The actuator of claim 1 wherein the movable portion of the actuator drive mechanism, the first rotatable actuator member, and the second rotatable actuator member are formed from a layer of polycrystalline silicon.

8. The actuator of claim 1 wherein the actuator drive mechanism comprises a parallel-plate electrostatic drive mechanism.

9. The actuator of claim 1 wherein the actuator drive mechanism comprises an interdigitated electrostatic drive mechanism.

10. The actuator of claim 1 wherein the actuator drive mechanism is selected from the group consisting of an electrostatic drive mechanism, a thermal drive mechanism, a piezoelectric drive mechanism, and a magnetic drive mechanism.

11. The actuator of claim 1 wherein a ratio of a displacement of at least a portion of the first rotatable actuator member to a displacement of the movable portion of the actuator drive mechanism is greater than one.

12. The actuator of claim 1 wherein a ratio of a displacement of at least a portion of the second rotatable actuator member to a displacement of the movable portion of the actuator drive mechanism is greater than two.

13. The actuator of claim 1 further comprising:
an optical element coupled to the second rotatable actuator member.

14. The actuator of claim 1 further comprising:
a third rotatable actuator member coupled to the second rotatable actuator member.

15. The actuator of claim 14 wherein the third rotatable actuator member is coupled to the substrate with at least one substrate hinge.

16. The actuator of claim 14 further comprising:
an optical element coupled to the third rotatable actuator member.

17. The actuator of claim 1 further comprising:
means for applying a first drive voltage to the movable portion of the actuator drive mechanism; and
means for applying a second drive voltage to a fixed portion of the actuator drive mechanism.

18. An optical subassembly for directing at least one beam of light comprising:
a plurality of micromirror assemblies on a substrate, wherein each micromirror assembly comprises an optical mirror operably coupled to at least one multistage rotatable actuator attached to the substrate.

19. The subassembly of claim 18 wherein each multistage rotatable actuator comprises a movable portion of an actuator drive mechanism coupled to the substrate, a first rotatable actuator member coupled to the movable portion of the actuator drive mechanism, and a second rotatable actuator member coupled to the first rotatable actuator member.

20. A method for actuating a micromirror assembly comprising:
applying a first control voltage to a movable portion of a multistage rotatable actuator,
applying a second control voltage to a fixed portion of the multistage rotatable actuator; and
positioning a micromirror coupled to at least one multistage rotatable actuator.

21. A system for actuating a micromirror assembly comprising:
means for applying a first control voltage to a movable portion of a multistage rotatable actuator,
means for applying a second control voltage to a fixed portion of the multistage rotatable actuator; and
means for positioning a micromirror coupled to at least one multistage rotatable actuator.
